(19) United States
(12) Patent Application Publication
(10) Pub. No.: US 2026/0149257 A1
(43) Pub. Date: May 28, 2026

(54) SYSTEMS AND METHODS FOR CREATING A TRAINING DATASET FOR AN ARTIFICIAL INTELLIGENCE-BASED ARC-FAULT INTERRUPTER CIRCUIT

(71) Applicant: STMicroelectronics International N.V., Geneva (CH)

(72) Inventors: Ruifeng PAN, Beijing (CN); Xiaoxian LI, Shanghai (CN); Ting LI, Shenzhen (CN); Matteo MARAVITA, Sai Kung (HK); Yuping SHU, Shanghai (CN)

(21) Appl. No.: 18/960,982

(22) Filed: Nov. 26, 2024

(51) Int. Cl. H02H 1/00

(52) U.S. Cl. CPC H02H 1/0092; H02H 1/0015

(57) ABSTRACT

In accordance with various embodiments, a method for creating a training dataset for an artificial intelligence-based arc-fault circuit interrupter is provided. In some embodiments, the method comprises collecting a number of frames of no-arc data, calculating a spectral amplitude value for each frame of no-arc data and summing the spectral amplitude values; calculating an average of the sums of the spectral amplitude values of the no-arc data; collecting a number of frames of arc data; calculating a spectral amplitude value for each frame of arc data and summing the spectral amplitude values; for each frame of arc data, comparing the sum of the spectral amplitude values to a threshold based on the average of the sums of the spectral amplitude values of the no-arc data; and adding each frame of arc data whose sum of the spectral amplitude values exceeds the threshold to an AI data model training dataset.

### FIELD OF THE INVENTION

Example embodiments of the present disclosure relate generally to arc-fault circuit interrupters and, more particularly, artificial intelligence-based arc-fault circuit interrupter.

### BACKGROUND

An arc-fault is an electrical discharge that occurs when electricity jumps between two or more conductors. In large scale photovoltaic (PV) solar power generation, it is important to provide arc-fault protection to prevent damage to expensive equipment. Such arc-fault protection is typically provided by an arc-fault circuit interrupter (AFCI). An AFCI is a device that detects an electric arc to enable a circuit to be rapidly closed to prevent damage from the electric arc.

Artificial intelligence (AI) is currently being used to train AFCIs to detect arc-faults. However, false positive detection is a challenge for artificial intelligence detection. A false positive (FP) refers to the occurrence of an arc being indicated by the arc detector equipment when an arc has not actually occurred. False positives are mainly caused by energy fluctuations in PV panels or switching noise in power electronic devices. False positives are disruptive because they cause the unnecessary shut down of power generation.

One of the reasons that AI trained AFCIs may produce false positives is because some of the data that corresponds to situations where an arc occurred (“arc data”) is very similar to some of the data that corresponds to situations where no arc occurred (“no-arc data”). This is illustrated in FIG. 1 which shows example data 100 comprising a large number of frames of spectral amplitude sums of no-arc data 105 and spectral amplitude sums of arc data 110. In the areas indicated by the large arrows, the arc data is very similar to the no-arc data. Thus, if this data is used to train an AI data model for arc-fault detection, the AI data model is more likely to produce false positives.

Applicant has identified many technical challenges and difficulties associated with the training of AI models for arc-fault detection. Through applied effort, ingenuity, and innovation, Applicant has solved problems related to the training of AI models for arc-fault detection by developing solutions embodied in the present disclosure, which are described in detail below.

### BRIEF SUMMARY

Various embodiments described herein related to systems and methods for creating a training dataset for an AI-based arc-fault circuit interrupter.

In accordance with various embodiments of the present disclosure, a method for creating a training dataset for an artificial intelligence (AI)-based arc-fault circuit interrupter is provided. In some embodiments, the method comprises collecting a predetermined number of frames of no-arc data corresponding to an electric current in which no instances of an arc current has occurred, each frame comprising a predetermined number of discrete data points; calculating a spectral amplitude value for each frame of no-arc data; for each frame of no-arc data, summing the calculated spectral amplitude values; calculating an average of the sums of the calculated spectral amplitude values of all of the frames of no-arc data; collecting a predetermined number of frames of arc data corresponding to an electric current in which at least one instance of an arc current has occurred, each frame comprising a predetermined number of discrete data points; calculating a spectral amplitude value for each frame of arc data; for each frame of arc data, summing the calculated spectral amplitude values; for each frame of arc data, comparing the sum of the spectral amplitude values to a threshold value that is based on the calculated average of the sums of the calculated spectral amplitude values of all of the frames of no-arc data; and adding each frame of arc data whose sum of the spectral amplitude values exceeds the threshold value to an AI data model training dataset.

In some embodiments, the method further comprises discarding each frame of arc data whose sum of the spectral amplitude values does not exceed the threshold value.

In some embodiments, the method further comprises, for each frame of no-arc data, prior to summing the calculated spectral amplitude values, removing an amplitude value corresponding to a fundamental wave, and for each frame of arc data, prior to summing the calculated spectral amplitude values, removing an amplitude value corresponding to a fundamental wave.

In some embodiments, the method further comprises, for each frame of no-arc data, prior to summing the calculated spectral amplitude values, removing noise, and for each frame of arc data, prior to summing the calculated spectral amplitude values, removing noise.

In some embodiments, the no-arc data and the arc data are collected from an electrical connection between one or more photovoltaic (PV) panels and a PV inverter.

In some embodiments, the no-arc data and the arc data are collected from an electrical connection between an arc generator and a PV inverter.

In some embodiments, the no-arc data and the arc data are collected using a current transformer positioned to detect electric current in an electrical connection between one or more PV panels and a PV inverter or between an arc generator and a PV inverter.

In some embodiments, the threshold value is based on a predetermined multiplier of the calculated average of the sums of the calculated spectral amplitude values of all of the no-arc data frames.

In some embodiments, comparing the sum of the spectral amplitude values for each frame of arc data to the threshold value comprises determining if an absolute value of (1 minus (the sum of the spectral amplitude values for the frame of arc data) divided by (the calculated average of the sums of the calculated spectral amplitude values of all of the no-arc data frames)) exceeds the threshold value.

In accordance with various embodiments of the present disclosure, a device for creating a training dataset for an artificial intelligence (AI)-based arc-fault circuit interrupter is provided. In some embodiments, the device comprises an arc generator adapted to be electrically connected between at least one photovoltaic (PV) panel and a PV inverter; a current sensing device adapted to detect an electric current in an electrical connection between the arc generator and the PV inverter; and an arc detection device configured to send an arc-triggering signal to the arc generator and receive one or more instances of a detected current signal from the current sensing device.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates example data showing spectral amplitude sums of no-arc data and spectral amplitude sums of arc data;

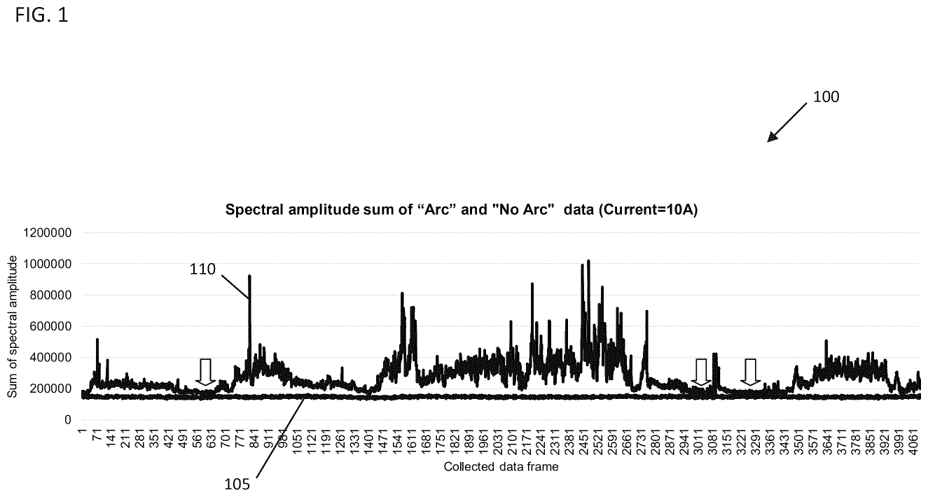

FIG. 2 is a block diagram of an example system for creating a training dataset for an AI-based arc-fault circuit interrupter, in accordance with some embodiments of the present disclosure;

FIG. 3 is a block diagram of an example arc detection device, in accordance with some embodiments of the present disclosure;

FIG. 4 provides an example flow diagram illustrating an example method for collecting no-arc data for creating a training dataset for an AI-based arc-fault circuit interrupter, in accordance with some embodiments of the present disclosure; and

FIG. 5 provides an example flow diagram illustrating an example method for collecting arc data for creating a training dataset for an AI-based arc-fault circuit interrupter, in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Various embodiments of the present disclosure overcome the above technical challenges and difficulties and provide various technical improvements and advantages based on, for example, but not limited to, providing example systems and methods for creating training datasets to be used to train an AI data model for arc fault protection. In various embodiments, arc data that is above a predetermined threshold is included in a dataset that is used to train the AI data model and arc data that is below the threshold is removed and not included in the dataset that is used to train the AI data model. In various embodiments, Multi-Layer Perceptron data model may be used to for the AI-based AFCI, however any suitable AI or machine learning data model may be used.

In various embodiments, frames of no-arc data (e.g., 512 or 1024 data points at a time) are gathered at various times and under various conditions. In various embodiments, a spectral analysis of the no-arc data is performed, such as by performing a Fast Fourier Transform (FFT), and the spectral amplitude values are summed for each frame. In various embodiments, once a sufficient number of no-arc data frames have been captured, the spectral amplitude sums are averaged for all the no-arc data frames.

In various embodiments, frames of arc data (e.g., 512 or 1024 data points at a time) are gathered at various times and under various conditions. This may be accomplished by using an arc generator to generate arcs and using a current transformer to collect the arcing current data. In various embodiments, a spectral analysis of the arc data is performed, such as by performing a Fast Fourier Transform (FFT), and the spectral amplitude values are summed for each frame. In various embodiments, for each frame of arc data, the spectral amplitude sum is compared to the average of the spectral amplitude sums for all the no-arc data frames. In various embodiments, only the frames of arc data for which the spectral amplitude sum exceeds the average of the spectral amplitude sums for all the no-arc data frames by a predetermined threshold are used to train the AI data model. That is, only arc data that has a sufficiently larger spectral amplitude as compared to the no-arc data is used to train the AI data model.

In various embodiments, the collection of arc data frames and the comparison of the arc data frames to the threshold continues until a sufficient number of arc data frames have been captured.

In various embodiments, the collection of arc data frames and no-arc data frames may occur in a laboratory or other pre-installation location and/or at a customer's installed location.

While embodiments of the present disclosure are described herein in relation to creating a training dataset for an AI-based AFCI for a PV installation, embodiments of the present disclosure may be used for creating a training dataset for an AI-based AFCI for any suitable application.

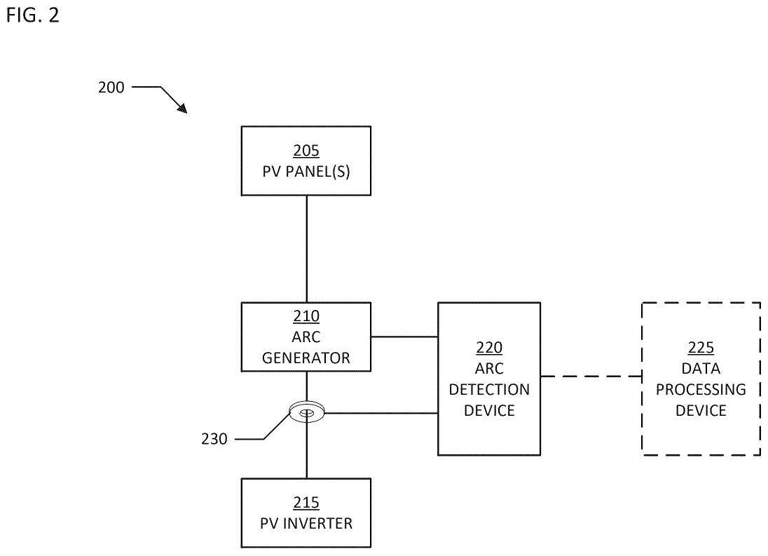

FIG. 2 illustrates an exemplary block diagram of an example system for creating a training dataset for an AI-based arc-fault circuit interrupter, in accordance with an example embodiment of the present disclosure. The example system 200 of FIG. 2 comprises one or more PV panels 205, a PV inverter 215, an arc generator 210 electrically connected between the PV panels 205 and the PV inverter 215, a current sensing device 230 to detect an electric current in the electrical connection between the arc generator 210 and the PV inverter 215, an arc detection device 220, and optionally a data processing device 225. In various embodiments, the arc generator 210 conforms to UL standard 1699B, however any suitable arc generator may be used. In various embodiments, the current sensing device 230 comprises a current transformer, however any suitable current sensing device may be used.

In various embodiments, the arc detection device 220 is configured to receive one or more instances of a detected current signal from the current sensing device 230. In various embodiments, the detected current from the current sensing device 230 is collected in frames of data (e.g., 512 or 1024 data points at a time) gathered at various times and under various conditions and at a suitable sampling rate (e.g., 250 kilohertz). In various embodiments, the detected current from the current sensing device 230 corresponds to current flowing from the one or more PV panels 205 to the PV inverter 215, and the current may include one or more arc faults (providing potential arc data, depending on the post-processing described below) or may include no arc faults (providing no-arc data).

Because the occurrence of arc faults is unpredictable, in various embodiments the arc detection device 220 is configured to send an arc-triggering signal to the arc generator 210 so that arc faults can be reliably produced and arc data can be reliably captured. In various embodiments, the arc detection device 220 comprises a user input device configured to cause the arc detection device 220 to send an arc-triggering signal to the arc generator 210 upon activation by a user. In various embodiments, the arc detection device 220 is configured to record the one or more instances of detected current signal upon activation of the user input device by the user. This ensures that the arc data is properly captured.

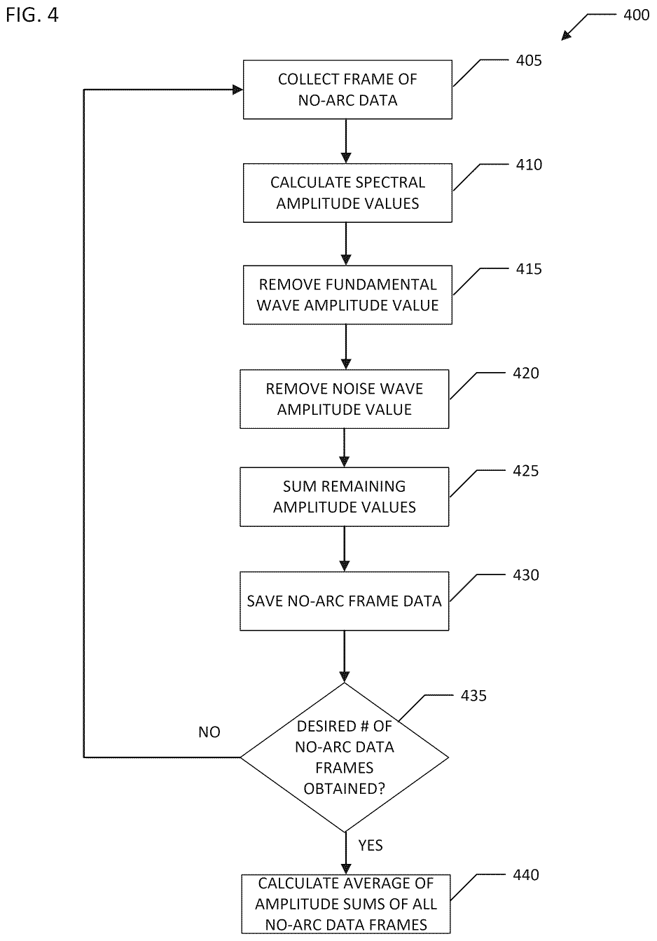

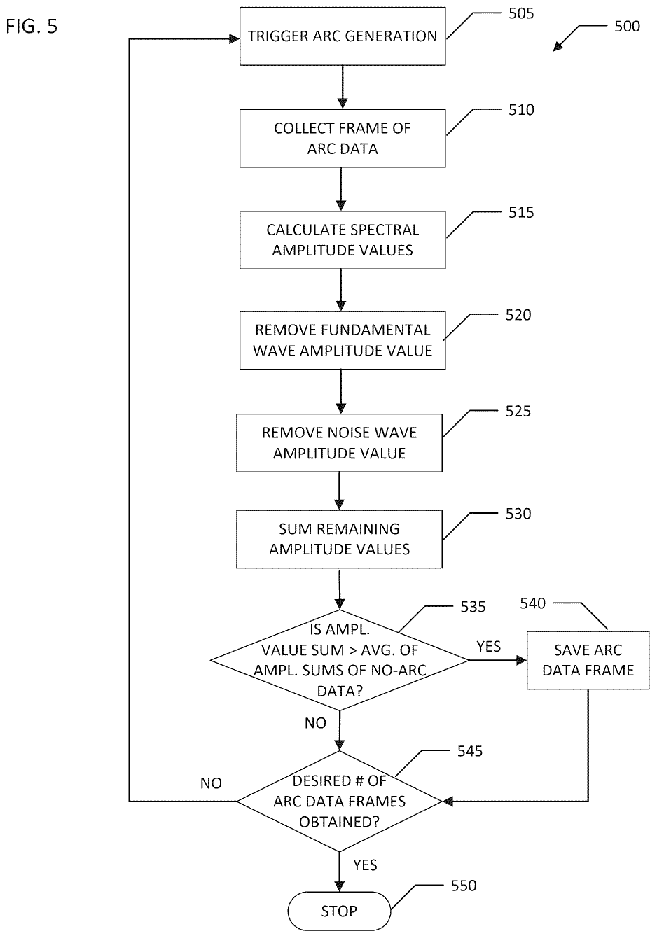

In various embodiments, the instances of detected current signal are post-processed as described below in relation to FIGS. 4 and 5 to ensure that only arc data that has a sufficiently larger spectral amplitude as compared to the no-arc data is used to train the AI data model. In this regard, embodiments of the present disclosure reduce the number of false positives in an AI-based AFCI. In various embodiments, this post-processing can be performed in the arc detection device 220, in the optional data processing device 225, or in any other suitable device. In various embodiments, the post-processed dataset is used to train an AI data model in the optional data processing device 225 or in any other suitable device. In various embodiments, the optional data processing device 225 comprises a personal computer (PC) or the like.

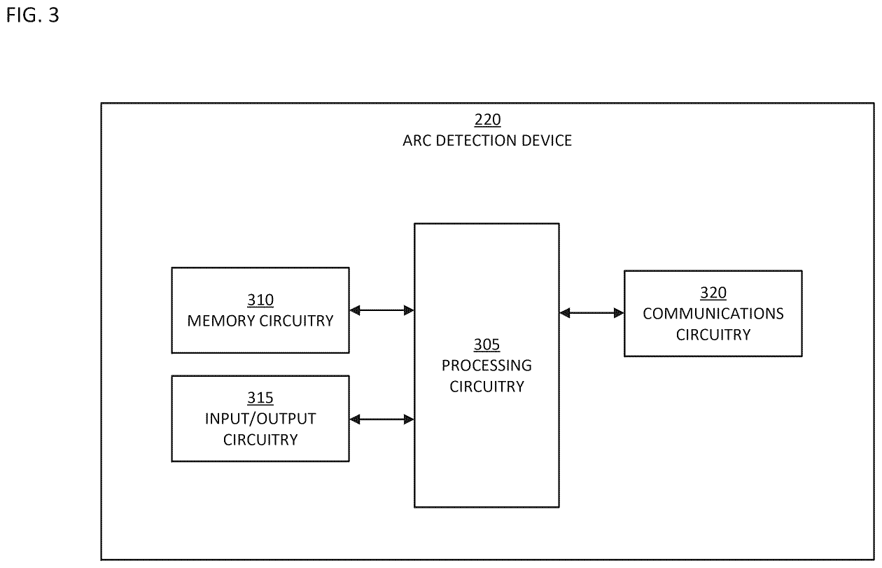

FIG. 3 depicts an example arc detection device 220 specially configured in accordance with at least some example embodiments of the present disclosure. The arc detection device 220 of FIG. 3 comprises processing circuitry 305, memory circuitry 310, input/output circuitry 315, communications circuitry 320, and a transducer array 110. In various embodiments, the arc detection device 220 is configured to execute and perform the operations described herein. For example, the arc detection device 220 may be configured to implement a method for creating a training dataset for an AI-based arc-fault circuit interrupter as described below in relation to FIGS. 4 and 5.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

Processing circuity 305 may be embodied in a number of different ways. In various embodiments, the use of the terms “processor,” “processing circuity,” “controller,” or “control circuitry” should be understood to include a single core processor, a multi-core processor, multiple processors internal to the arc detection device 220, and/or one or more remote or “cloud” processor(s) external to the arc detection device 220. In some example embodiments, processing circuitry 305 may include one or more processing devices configured to perform independently. Alternatively, or additionally, processing circuitry 305 may include one or more processor(s) configured in tandem via a bus to enable independent execution of operations, instructions, pipelining, and/or multithreading.

In an example embodiment, the processing circuitry 305 may be configured to execute instructions stored in the memory circuitry 310 or otherwise accessible to the processor. Alternatively, or additionally, the processing circuitry 305 may be configured to execute hard-coded functionality. As such, whether configured by hardware or software methods, or by a combination thereof, processing circuitry 305 may represent an entity (e.g., physically embodied in circuitry) capable of performing operations according to embodiments of the present disclosure while configured accordingly. Alternatively, or additionally, processing circuitry 305 may be embodied as an executor of software instructions, and the instructions may specifically configure the processing circuitry 305 to perform the various algorithms embodied in one or more operations described herein when such instructions are executed. In some embodiments, the processing circuitry 305 includes hardware, software, firmware, and/or a combination thereof that performs one or more operations described herein.

In some embodiments, the processing circuitry 305 (and/or co-processor or any other processing circuitry assisting or otherwise associated with the processor) is/are in communication with the memory circuitry 310 via a bus for passing information among components of the arc detection device 220.

Memory or memory circuitry 310 may be non-transitory and may include, for example, one or more volatile and/or non-volatile memories. In some embodiments, the memory circuitry 310 includes or embodies an electronic storage device (e.g., a computer readable storage medium). In some embodiments, the memory circuitry 310 is configured to store information, data, content, applications, instructions, or the like, for enabling an arc detection device 220 to carry out various operations and/or functions in accordance with example embodiments of the present disclosure.

Input/output circuitry 315 may be included in the arc detection device 220. In some embodiments, input/output circuitry 315 may provide output to the user and/or receive input from a user. The input/output circuitry 315 may be in communication with the processing circuitry 305 to provide such functionality. The input/output circuitry 315 may comprise one or more user interface(s). In some embodiments, a user interface may include a display that comprises the interface(s) rendered as a web user interface, an application user interface, a user device, a backend system, or the like. In some embodiments, the input/output circuitry 315 also includes analog sampling circuits, a keyboard, a mouse, a joystick, a touch screen, touch areas, soft keys a microphone, a speaker, or other input/output mechanisms. The processing circuitry 305 and/or input/output circuitry 315 may be configured to control one or more operations and/or functions of one or more user interface elements through computer program instructions (e.g., software and/or firmware) stored on a memory accessible to the processor (e.g., memory circuitry 310, and/or the like). In some embodiments, the input/output circuitry 315 includes or utilizes a user-facing application to provide input/output functionality to a computing device and/or other display associated with a user. In various embodiments, the input/output circuitry 315 comprises the user input device described above that is configured to cause the arc detection device 220 to send an arc-triggering signal to the arc generator 210 upon activation by a user.

Communications circuitry 320 may be included in the arc detection device 220. The communications circuitry 320 may include any means such as a device or circuitry embodied in either hardware or a combination of hardware and software that is configured to receive and/or transmit data from/to a network and/or any other device, circuitry, or module in communication with the arc detection device 220. In some embodiments the communications circuitry 320 includes, for example, a network interface for enabling communications with a wired or wireless communications network. Additionally or alternatively, the communications circuitry 320 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 320 may include circuitry for interacting with an antenna(s) and/or other hardware or software to cause transmission of signals via the antenna(s) and/or to handle receipt of signals received via the antenna(s). In some embodiments, the communications circuitry 320 enables transmission to and/or receipt of data from a user device, one or more sensors, and/or other external computing device(s) in communication with the arc detection device 220, such as the data processing device 225.

In some embodiments, two or more of the sets of circuitry 305-320 are combinable. Alternatively, or additionally, one or more of the sets of circuitry 305-320 perform some or all of the operations and/or functionality described herein as being associated with another circuitry. In some embodiments, two or more of the sets of circuitry 305-320 are combined into a single module embodied in hardware, software, firmware, and/or a combination thereof.

Reference will now be made to FIGS. 4 and 5 which provides flowcharts illustrating example steps, processes, procedures, and/or operations in accordance with various embodiments of the present disclosure. Various methods described herein, including, for example, example methods as shown in FIGS. 4 and 5, may provide various technical benefits and improvements. It is noted that each block of the flowchart, and combinations of blocks in the flowchart, may be implemented by various means such as hardware, firmware, circuitry and/or other devices associated with execution of software including one or more computer program instructions. For example, one or more of the procedures described in FIGS. 4 and 5 may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

Referring now to FIG. 4, an example flow diagram illustrating an example method 400 for collecting no-arc data for creating a training dataset for an AI-based arc-fault circuit interrupter in accordance with some embodiments of the present disclosure is illustrated. In some embodiments, the example method 400 may be implemented by an example arc detection device described herein, including, but not limited to, the example arc detection device described above in connection with FIGS. 2 and 3.

The example method 400 shown in FIG. 4 starts at step/operation 405. At step/operation 405, a processor (such as, but not limited to, the processing circuitry 305 of the arc detection device 220 described above in connection with FIGS. 2 and 3, in conjunction with the current sensing device 230 described above in connection with FIG. 2) collects a frame of no-arc data. In various embodiments, each frame of no-arc data has a predetermined number of data points (e.g., 512 or 1024) and is gathered at various times and under various conditions. As described above, the no-arc data frame may be collected using a current sensing device such as a current transformer.

At step/operation 410, a processor (such as, but not limited to, the processing circuitry 305 of the arc detection device 220 described above in connection with FIGS. 2 and 3) calculates the spectral amplitude values of the no-arc data in each frame, such as by performing a Fast Fourier Transform (FFT).

At step/operation 415, a processor (such as, but not limited to, the processing circuitry 305 of the arc detection device 220 described above in connection with FIGS. 2 and 3) removes the amplitude value corresponding to the fundamental component of the spectrum.

At step/operation 420, a processor (such as, but not limited to, the processing circuitry 305 of the arc detection device 220 described above in connection with FIGS. 2 and 3) removes the amplitude value corresponding to the noise wave (e. g, at known noise frequency points, such as the switching frequency of an inverter).

At step/operation 425, a processor (such as, but not limited to, the processing circuitry 305 of the arc detection device 220 described above in connection with FIGS. 2 and 3) sums the remaining (i.e., after the amplitude value corresponding to the fundamental component and the amplitude value corresponding to the noise wave are removed) spectral amplitude values for the frame of no-arc data.

At step/operation 430, a processor (such as, but not limited to, the processing circuitry 305 of the arc detection device 220 described above in connection with FIGS. 2 and 3) saves the frame of no-arc data as part of a dataset to be used for training an AI-based AFCI.

At step/operation 435, a processor (such as, but not limited to, the processing circuitry 305 of the arc detection device 220 described above in connection with FIGS. 2 and 3) determines if the desired number of no-arc frames have been obtained. Any suitable number of no-arc frames may be obtained for use in training an AI-based AFCI. In one example embodiment, no-arc frames are collected according to steps/operations 405-430 until 2000 no-arc frames are obtained.

If it is determined at step/operation 435 that the desired number of no-arc frames have not been obtained, the method 400 returns to step/operation 405. If it is determined at step/operation 435 that the desired number of no-arc frames have been obtained, the method 400 continues to step/operation 440.

At step/operation 440, a processor (such as, but not limited to, the processing circuitry 305 of the arc detection device 220 described above in connection with FIGS. 2 and 3) calculates an average of the spectral amplitude sums for all the no-arc data frames. In various embodiments, this average value is saved and used to obtain arc data to be used for training an AI-based AFCI, such as via the method of FIG. 5.

Referring now to FIG. 5, an example flow diagram illustrating an example method 500 for collecting arc data for creating a training dataset for an AI-based arc-fault circuit interrupter in accordance with some embodiments of the present disclosure is illustrated. In some embodiments, the example method 500 may be implemented by an example arc detection device described herein, including, but not limited to, the example arc detection device described above in connection with FIGS. 2 and 3.

The example method 500 shown in FIG. 5 starts at step/operation 505. At step/operation 505, a processor (such as, but not limited to, the processing circuitry 305 of the arc detection device 220 described above in connection with FIGS. 2 and 3, in conjunction with the arc generator 210 described above in connection with FIG. 2) triggers an arc on an electrical connection leading to a PV inverter. As described above, this may be triggered by a user action, such as pushing a pushbutton on the arc detection device 220.

At step/operation 510, a processor (such as, but not limited to, the processing circuitry 305 of the arc detection device 220 described above in connection with FIGS. 2 and 3, in conjunction with the current sensing device 230 described above in connection with FIG. 2) collects a frame of arc data. In various embodiments, each frame of arc data has a predetermined number of data points (e.g., 512 or 1024) and is gathered at various times and under various conditions. As described above, the arc data frame may be collected using a current sensing device such as a current transformer.

At step/operation 515, a processor (such as, but not limited to, the processing circuitry 305 of the arc detection device 220 described above in connection with FIGS. 2 and 3) calculates the spectral amplitude values of the arc data in each frame, such as by performing a Fast Fourier Transform (FFT).

At step/operation 520, a processor (such as, but not limited to, the processing circuitry 305 of the arc detection device 220 described above in connection with FIGS. 2 and 3) removes the amplitude value corresponding to the fundamental component of the spectrum.

At step/operation 525, a processor (such as, but not limited to, the processing circuitry 305 of the arc detection device 220 described above in connection with FIGS. 2 and 3) removes the amplitude value corresponding to the noise wave (e.g., at known noise frequency points, such as the switching frequency of an inverter).

At step/operation 530, a processor (such as, but not limited to, the processing circuitry 305 of the arc detection device 220 described above in connection with FIGS. 2 and 3) sums the remaining (i.e., after the amplitude value corresponding to the fundamental component and the amplitude value corresponding to the noise wave are removed) spectral amplitude values for the frame of arc data.

At step/operation 535, a processor (such as, but not limited to, the processing circuitry 305 of the arc detection device 220 described above in connection with FIGS. 2 and 3) compares the sum of the spectral amplitude values for the frame of arc data determined at step/operation 530 to the average of the spectral amplitude sums for all the no-arc data frames determined at step/operation 440 of the method 400 of FIG. 4 and determines if the sum of the spectral amplitude values for the frame of arc data determined at step/operation 530 exceeds the average of the spectral amplitude sums for all the no-arc data frames by a predetermined amount.

In some embodiments, the sum of the spectral amplitude values is compared to a threshold value that is based on the calculated average of the sums of the calculated spectral amplitude values of all of the frames of no-arc data. In some embodiments, the threshold value is based on multiplying the calculated average of the sums of the calculated spectral amplitude values of all of the frames of no-arc data by a predetermined filter coefficient or one of a predetermined range of filter coefficients. For example, a predetermined range of filter coefficients may be 1.1. to 3.9, with an example of a specific value chosen being 1.5. That, in one example, the calculated average of the sums of the calculated spectral amplitude values of all of the frames of no-arc data is multiplied by 1.5 to determine the threshold against which the sum of the spectral amplitude values of each frame of arc data is compared. In some embodiments, comparing the sum of the spectral amplitude values for each frame of arc data to the threshold value comprises determining if an absolute value of (1−(the sum of the spectral amplitude values for the frame of arc data)/(the calculated average of the sums of the calculated spectral amplitude values of all of the no-arc data frames)) exceeds the threshold value.

The specific value of the filter coefficient may be selected based the desired performance of the AI-based AFCI. For example, a lower filter coefficient is likely to lead to more false positives while a higher filter coefficient is likely to lead to more false negatives (i.e., missed arcs).

If it is determined at step/operation 535 that the sum of the spectral amplitude values for the frame of arc data determined at step/operation 530 exceeds the average of the spectral amplitude sums for all the no-arc data frames by a predetermined amount, the method 500 proceeds to step/operation 540.

At step/operation 540, a processor (such as, but not limited to, the processing circuitry 305 of the arc detection device 220 described above in connection with FIGS. 2 and 3) saves the frame of arc data as part of a dataset to be used for training an AI-based AFCI. The method 500 proceeds to step/operation 540.

If it is determined at step/operation 535 that the sum of the spectral amplitude values for the frame of arc data determined at step/operation 530 does not exceed the average of the spectral amplitude sums for all the no-arc data frames by a predetermined amount, the frame of arc data is not saved and may be discarded and the method 500 proceeds to step/operation 545. With this determination, the frame of arc data is not saved or used for the AI model training dataset because the amplitude sum of the frame of arc data is too close to the average of the sums of the non-arc data and is therefore more likely to lead an AFCI trained with such a frame to have more false positives.

At step/operation 545, a processor (such as, but not limited to, the processing circuitry 305 of the arc detection device 220 described above in connection with FIGS. 2 and 3) determines if the desired number of arc frames have been obtained. Any suitable number of arc frames may be obtained for use in training an AI-based AFCI. In one example embodiment, arc frames are collected according to steps/operations 505-540 until 2000 arc frames are obtained.

If it is determined at step/operation 545 that the desired number of arc frames have not been obtained, the method 500 returns to step/operation 505. If it is determined at step/operation 545 that the desired number of arc frames have been obtained, the method 500 ends at step/operation 550.

In various embodiments, the example method 400 and the example method 500 may run once to obtain a dataset to be used for training an AI-based AFCI and may be run periodically (e.g., on a predetermined schedule) to update the dataset and thereby update the training of the AI-based AFCI.

In various embodiments, an arc detection device continues to monitor the current in the electrical connection to the PV inverter for additional data that may be used to update the training of the AI model for the AFCI. In particular, the arc detection device may continue to monitor to identify false positives (i.e., when the AFCI indicates an arc has occurred but there has been no arc). Such false positive data can indicate that the filter coefficient was set too low and the dataset may need to be reprocessed with a different filter coefficient. Such ongoing data may be saved in memory on the arc detection device (such as in a removable memory card) and/or uploaded to a data processing device.

Various embodiments of the present disclosure can reduce false positives in photovoltaic arc detection systems with little to no loss of arc detection accuracy.

### CONCLUSION

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

While this detailed description has set forth some embodiments of the present disclosure, the appended claims cover other embodiments of the present disclosure which differ from the described embodiments according to various modifications and improvements. For example, the appended claims can cover any form of device which captures arc data and no-arc data and processes that data for use in training an AI data model.

Within the appended claims, unless the specific term “means for” or “step for” is used within a given claim, it is not intended that the claim be interpreted under 35 U.S.C. 112, paragraph 6.

What is claimed is:

1. A method for creating a training dataset for an artificial intelligence (AI)-based arc-fault circuit interrupter, the method comprising:
collecting a predetermined number of frames of no-arc data corresponding to an electric current in which no instances of an arc current has occurred, each frame comprising a predetermined number of discrete data points;
calculating a spectral amplitude value for the no-arc data in each frame;
for each frame of no-arc data, summing the calculated spectral amplitude values;
calculating an average of the sums of the calculated spectral amplitude values of all of the frames of no-arc data;
collecting a predetermined number of frames of arc data corresponding to an electric current in which at least one instance of an arc current has occurred, each frame comprising a predetermined number of discrete data points;
calculating a spectral amplitude value for the arc data in each frame;
for each frame of arc data, summing the calculated spectral amplitude values;
for each frame of arc data, comparing the sum of the spectral amplitude values to a threshold value that is based on the calculated average of the sums of the calculated spectral amplitude values of all of the frames of no-arc data; and
adding each frame of arc data whose sum of the spectral amplitude values exceeds the threshold value to an AI data model training dataset.

2. The method of claim 1, further comprising discarding each frame of arc data whose sum of the spectral amplitude values does not exceed the threshold value.

3. The method of claim 1, further comprising:
for each frame of no-arc data, prior to summing the calculated spectral amplitude values, removing an amplitude value corresponding to a fundamental wave; and
for each frame of arc data, prior to summing the calculated spectral amplitude values, removing an amplitude value corresponding to a fundamental wave.

4. The method of claim 1, further comprising:
for each frame of no-arc data, prior to summing the calculated spectral amplitude values, removing noise; and
for each frame of arc data, prior to summing the calculated spectral amplitude values, removing noise.

5. The method of claim 1, wherein the no-arc data and the arc data are collected from an electrical connection between one or more photovoltaic (PV) panels and a PV inverter.

6. The method of claim 1, wherein the no-arc data and the arc data are collected from an electrical connection between an arc generator and a PV inverter.

7. The method of claim 1, wherein the no-arc data and the arc data are collected using a current transformer positioned to detect electric current in an electrical connection between one or more PV panels and a PV inverter or between an arc generator and a PV inverter.

8. The method of claim 1, wherein the threshold value is based on a predetermined multiplier of the calculated average of the sums of the calculated spectral amplitude values of all of the no-arc data frames.

9. The method of claim 1, wherein comparing the sum of the spectral amplitude values for each frame of arc data to the threshold value comprises determining if an absolute value of (1 minus (the sum of the spectral amplitude values for the frame of arc data) divided by (the calculated average of the sums of the calculated spectral amplitude values of all of the no-arc data frames)) exceeds the threshold value.

10. A system for creating a training dataset for an artificial intelligence (AI)-based arc-fault circuit interrupter, the system comprising:
an arc generator adapted to be electrically connected between at least one photovoltaic (PV) panel and a PV inverter;
a current sensing device adapted to detect an electric current in an electrical connection between the arc generator and the PV inverter; and
an arc detection device configured to send an arc-triggering signal to the arc generator and receive one or more instances of a detected current signal from the current sensing device.

11. The system of claim 10, wherein the current sensing device comprises a current transformer adapted to at least partially surround the electrical connection between the arc generator and the PV inverter.

12. The system of claim 10, further comprising a user input device configured to cause the arc detection device to send an arc-triggering signal to the arc generator upon activation by a user.

13. The system of claim 12, wherein the arc detection device is further configured to start recording the detected current signal from the current sensing device upon activation of the user input device by the user.

14. The system of claim 10, wherein the arc detection device is further configured to:
identify, from the one or more instances of detected current signal from the current sensing device, a predetermined number of frames of no-arc data corresponding to an electric current in which no instances of an arc current has occurred, each frame comprising a predetermined number of discrete data points;
calculate a spectral amplitude value for the no-arc data in each frame;
for each frame of no-arc data, sum the calculated spectral amplitude values;
calculate an average of the sums of the calculated spectral amplitude values of all of the frames of no-arc data;
identify, from the one or more instances of detected current signal from the current sensing device, a predetermined number of frames of arc data corresponding to an electric current in which at least one instance of an arc current has occurred, each frame comprising a predetermined number of discrete data points;
calculate a spectral amplitude value for the arc data in each frame;
for each frame of arc data, sum the calculated spectral amplitude values;
for each frame of arc data, compare the sum of the spectral amplitude values to a threshold value that is based on the calculated average of the sums of the calculated spectral amplitude values of all of the frames of no-arc data; and
add each frame of arc data whose sum of the spectral amplitude values exceeds the threshold value to an AI data model training dataset.

15. The system of claim 14, wherein the arc detection device is further configured to:
for each frame of no-arc data, prior to summing the calculated spectral amplitude values, remove an amplitude value corresponding to a fundamental wave; and
for each frame of arc data, prior to summing the calculated spectral amplitude values, remove an amplitude value corresponding to a fundamental wave.

16. The system of claim 14, wherein the arc detection device is further configured to:
for each frame of no-arc data, prior to summing the calculated spectral amplitude values, remove noise; and
for each frame of arc data, prior to summing the calculated spectral amplitude values, remove noise.

17. The system of claim 14, wherein the threshold value is based on a predetermined multiplier of the calculated average of the sums of the calculated spectral amplitude values of all of the no-arc data frames.

18. The system of claim 14, wherein comparing the sum of the spectral amplitude values for each frame of arc data to the threshold value comprises determining if an absolute value of (1 minus (the sum of the spectral amplitude values for the frame of arc data) divided by (the calculated average of the sums of the calculated spectral amplitude values of all of the no-arc data frames)) exceeds the threshold value.
